(19) United States
(12) Patent Application Publication
(10) Pub. No.: US 2017/0361596 A1
(43) Pub. Date: Dec. 21, 2017

(54) METHOD FOR COATING NON-METAL OBJECT WITH METALLIC LAYER

(71) Applicant: Kuo-Ping Feng, Walnut, CA (US)

(72) Inventor: Kuo-Ping Feng, Walnut, CA (US)

(21) Appl. No.: 15/629,484

(22) Filed: Jun. 21, 2017

Related U.S. Application Data
(60) Provisional application No. 62/352,986, filed on Jun. 21, 2016.

(51) Int. Cl. B32B 27/40; B29C 33/44; B29C 33/02; B32B 9/02; B32B 37/06; B32B 37/14

(52) U.S. Cl. CPC B32B 27/40; B32B 37/06; B32B 37/14; B29C 33/02; B32B 9/025; B29C 33/44; B32B 2262/101

(57) ABSTRACT

A method for coating a non-metal object with a metallic layer may include steps of manufacturing a polyurethane (PU) leather with a metallic surface; attaching a composite material to a surface of the PU leather with the metallic surface; and molding. Comparing with conventional coating techniques such as oil injection and electroplating, the present invention is advantageous because the manufacturing process is simple to lower the manufacturing cost, and also the manufactured product is abrasive and bending-resistance, as well as crease-resistant. Furthermore, since each of the upper cavity and the lower cavity communicates with the gas vent, the pressure inside the mold can be well-maintained during the molding process thereby preventing the molding product from defect causing by excessive pressure.

### CROSS-REFERENCE TO RELATED APPLICATIONS

This application claims priority under 35 U.S.C. §119 (e) to U.S. Provisional Patent Application Ser. No. 62/352,986 filed on Jun. 21, 2016, the entire contents of which are hereby incorporated by reference.

### FIELD OF THE INVENTION

The present invention relates to a coating technique, and more particularly to a coating technique that is configured to coat a metallic layer to a surface of a non-metal object.

### BACKGROUND OF THE INVENTION

Nowadays, oil injection and electroplating are two main approaches for coating a metallic layer on a non-metal object such as toys, animation merchandises, sports products, etc. to form a silver and reflective surface. Although these two methods can successfully achieve the purpose of coating, they are still disadvantageous because (i) the process are expensive and complicated, and the coating layer is not anti-wearing and scratch-resistant, so it is easy to wrinkle and fall off; and (ii) the coating layer is supported by a frame inside which is formed of metals or packed by other fragile materials, so it may hurt a user when the frame is cracked or protrudes from the surface of the coating layer accidentally. Therefore, there remains a need for a new and improved design for a coating technique for non-metal object to overcome the problems presented above.

### SUMMARY OF THE INVENTION

The invention provides a coating technique for non-metal object which comprises the following steps:

step S101: manufacturing a polyurethane (PU) leather with a metallic surface, which may further include steps of: dissolving the PU resin in an organic solvent to form a compound; heating the compound at a predetermined heating temperature for attaching the compound to a base fabric to manufacture a PU leather, wherein the base fabric can be a tetoron/cotton (T/C) fabric or a mutispandex fabric; coating gold stamping oil on a surface of the PU leather, and attaching a gold stamping foil on the surface of the PU leather through a hot stamping machine; and disposing a transparent protective film on a surface of the gold stamping foil;

step S102: laminating, which may further include a step of attaching a composite material to the surface of the PU leather with the metallic surface in step S101;

step S103: molding, which may further include steps of: according to a shape of a final product, preparing an upper mold and a lower mold, and the upper mold and the lower mold respectively having an upper mold cavity and a lower mod cavity, and a gas vent to communicate with both the upper mold cavity and the lower mold cavity; securing the upper mold and the lower mold onto a cold press machine; heating the semi-manufactured product in step S102 in an oven until the conditions that composite material being shaped; taking out the semi-manufactured product and directly putting it into the lower molding cavity with a non-metal composite material as a backbone of the final product; closing the cold press machine to tightly combine the upper mold with the lower mold and processing the semi-manufactured product inside the cavities with a predetermined pressure and blowing air to form the semi-manufactured product into the designated shape; cooling down the semi-manufactured product in the cavities to a predetermined temperature by simultaneously cooling down the upper mold and the lower mold; and opening the cold press machine, taking out and trimming the product therein to complete the manufacturing process thereof.

In one embodiment, in step S101, the organic solvent can be dimethylformamide (DMF).

In another embodiment, in step S101, the heating temperature is between 130 to 140° C.

In a further embodiment, in step S101, the operating temperature of the hot stamping machine is 110 to 130° C., and the operating pressure is 10 to 60 KG.

In still a further embodiment, in step S101, the protective film can be made by poly(vinyl chloride) (PVC), ethylene vinyl acetate (EVA), thermoplastic elastomer (TPE), or thermoplastic polyurethane (TPU).

In yet a further embodiment, in step S101, the thickness of the protective film is ranging from 0.12 to 0.16 mm.

In a particular embodiment, in step S102, the composite material can be ethylene vinyl acetate (EVA), cross-linked polyethylene foam (XPE), or chemically cross-linked polyethylene foam (XLPE).

In a preferred embodiment, in step S103, the upper mold and the lower mold are made by aluminum or steel.

In still a preferred embodiment, the non-metal composite material as a backbone of the final product is fiberglass.

Comparing with conventional coating techniques, the present invention is advantageous because: (i) the manufacturing process is simple to lower the manufacturing cost, and also the manufactured product is abrasive and bending-resistance, as well as crease-resistant; (ii) since each of the upper cavity and the lower cavity communicates with the gas vent, the pressure inside the mold can be well-maintained during the molding process thereby preventing the molding product from defect causing by excessive pressure; and (iii) the product is molded in the cold press machine, so the requirement of the mold quality is not high, so the cost of molds during the manufacturing process can be reduced.

### BRIEF DESCRIPTION OF THE DRAWINGS

FIG. 1 is a flow chart illustrating the process of a coating method for non-metal object with a metallic layer in the present invention.

FIG. 2 is a schematic view of a non-metal weaponry instrument with the metallic layer in the present invention.

FIG. 2a is an exploded view of the non-metal weaponry instrument with the metallic layer in the present invention.

FIG. 3 is a schematic view of the non-metal weaponry instrument in the present invention when it is assembled.

FIG. 4 is another exploded view of the non-metal weaponry instrument with the metallic layer in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

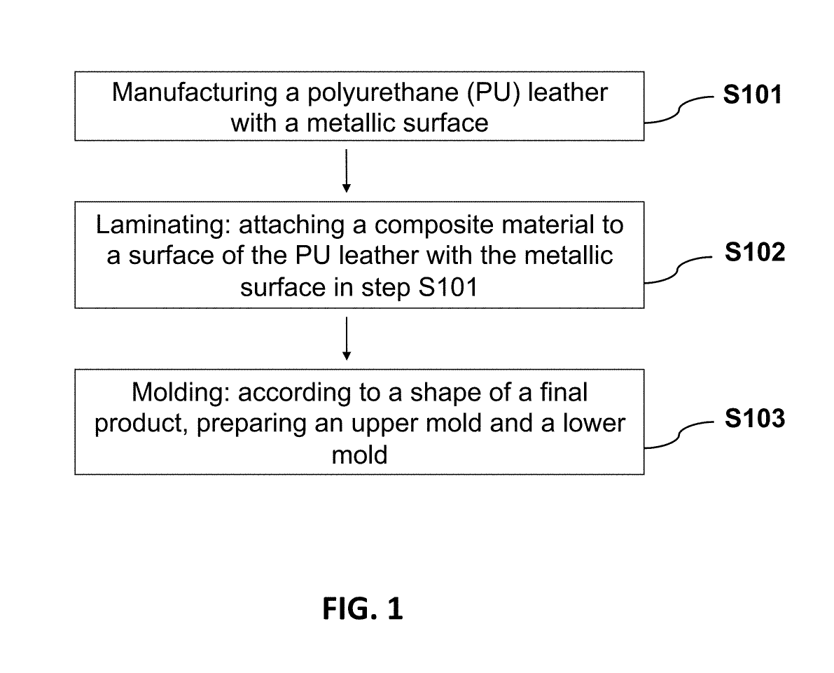

Referring to FIG. 1, the present invention provides a method for coating a metallic layer onto a non-metal weaponry instrument, which comprises the following steps:

step S101: manufacturing a polyurethane (PU) leather with a metallic surface, which may further include steps of: dissolving the PU resin in an organic solvent to form a compound; heating the compound at a predetermined heating temperature for attaching the compound to a base fabric to manufacture a PU leather, wherein the base fabric can be a tetoron/cotton (T/C) fabric or a mutispandex fabric; coating gold stamping oil on a surface of the PU leather, and attaching a gold stamping foil on the surface of the PU leather through a hot stamping machine; and disposing a transparent protective film on a surface of the gold stamping foil;

step S102: laminating, which may further include a step of attaching a composite material to the surface of the PU leather with the metallic surface in step S101;

step S103: molding, which may further include steps of: according to a shape of a final product, preparing an upper mold and a lower mold, and the upper mold and the lower mold respectively having an upper mold cavity and a lower mod cavity, and a gas vent to communicate with both the upper mold cavity and the lower mold cavity; securing the upper mold and the lower mold onto a cold press machine; heating the semi-manufactured product in step S102 in an oven until the conditions that composite material being shaped; taking out the semi-manufactured product and directly putting it into the lower molding cavity with a non-metal composite material as a backbone of the final product; closing the cold press machine to tightly combine the upper mold with the lower mold and processing the semi-manufactured product inside the cavities with a predetermined pressure and blowing air to form the semi-manufactured product into the designated shape; cooling down the semi-manufactured product in the cavities to a predetermined temperature by simultaneously cooling down the upper mold and the lower mold; and opening the cold press machine, taking out and trimming the product therein to complete the manufacturing process thereof.

In one embodiment, in step S101, the mutispandex fabric can be applied in toys, clothing, bags, sporting equipment, etc., and the T/C fabric is a polyester/cotton fabric or a polyester/cotton yarn with over 50% polyester therein.

In another embodiment, in step S101, the organic solvent can be dimethylformamide (DMF) which is a transparent liquid and can be mutually soluble with water and most organic solvents.

In still another embodiment, in step S101, the heating temperature is between 130 and 140° C., and a preferred heating temperature in the present invention is 135° C.

In a further embodiment, in step S101, the main component of the gold stamping oil is acrylic resin which is a copolymer generated through a chemical reaction by applying acrylic ester, methyl methacrylate monomer (MMA) and other allyl monomers. The viscosity of the gold stamping oil is determined by the acrylic resin and is a major factor determining adhesive effect between the gold stamping foil and the surface of the PU leather.

In still a further embodiment, in step S101, the operating temperature of the hot stamping machine is between 110 and 130° C., and a preferred operating temperature is 120° C. Also, a preferred operating pressure of the hot stamping machine is 30 KG. Thus, by maintaining the operating temperature and pressure during operation, the gold stamping foil can firmly attach on the surface of the PU leather through the gold stamping oil thereby forming a metallic reflective surface.

In yet a further embodiment, in step S101, the protective film can be made by poly(vinyl chloride) (PVC), ethylene vinyl acetate (EVA), thermoplastic elastomer (TPE), or thermoplastic polyurethane (TPU), and is configured to enhance the metallic and reflective effect on the surface of the PU leather, and make the product abrasive and bending-resistant.

In a particular embodiment, in step S101, the thickness of the protective film, which is a main factor to determine the surface reflectiveness and abrasive resistance of the product, is in a range from 0.12 to 0.16 mm, and a preferred thickness of the protective film is 0.13 mm.

In still a particular embodiment, in step S102, the composite material can be made by ethylene vinyl acetate (EVA), chemically cross-linked polyethylene foam (XLPE), or cross-linked polyethylene foam (XPE).

In a preferred embodiment, in step S103, the upper mold and the lower mold can be made by aluminum or steel.

In still a preferred embodiment, the non-metal composite material as a backbone of the final product is fiberglass.

In an advantageous embodiment, in step S103, the final product can be artificial animal horns, toys, gifts, artworks, crafts, ornaments or tires or anti-slip products.

Comparing with conventional coating techniques, the present invention is advantageous because: (i) the manufacturing process is simple to lower the manufacturing cost, and also the manufactured product is abrasive and bending-resistance, as well as crease-resistant; (ii) since each of the upper cavity and the lower cavity communicates with the gas vent, the pressure inside the mold can be well-maintained during the molding process thereby preventing the molding product from defect causing by excessive pressure; and (iii) the product is molded in the cold press machine, so the requirement of the mold quality is not high, so the cost of molds during the manufacturing process can be reduced.

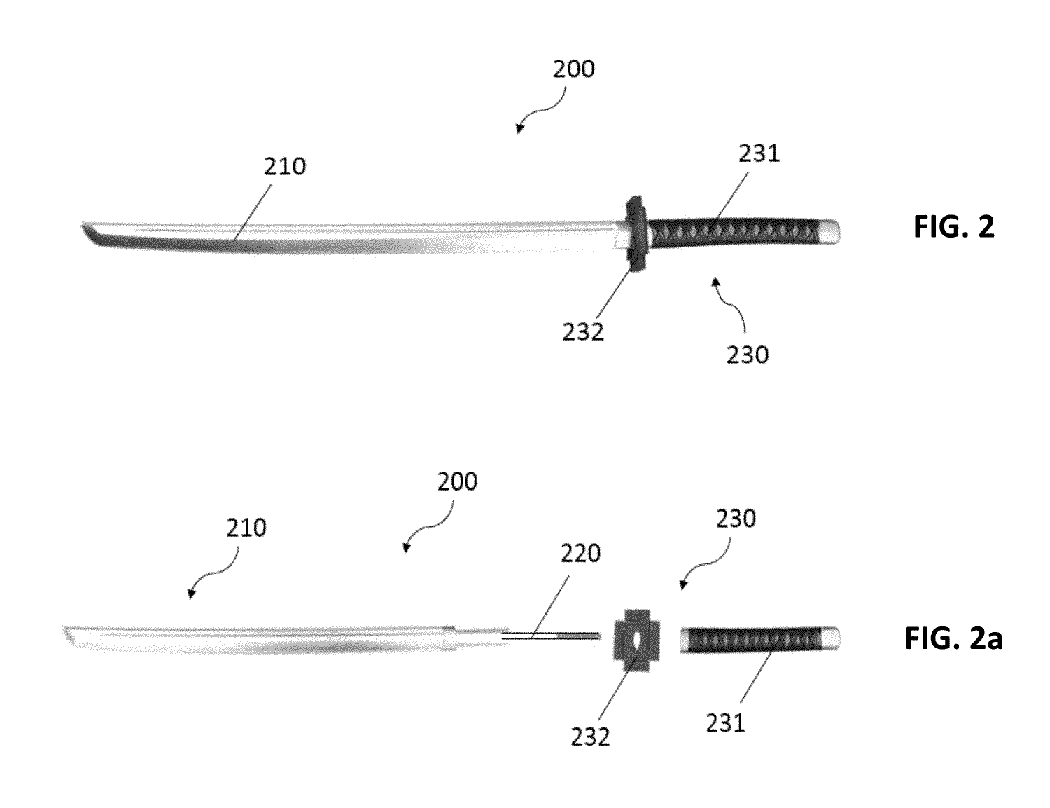

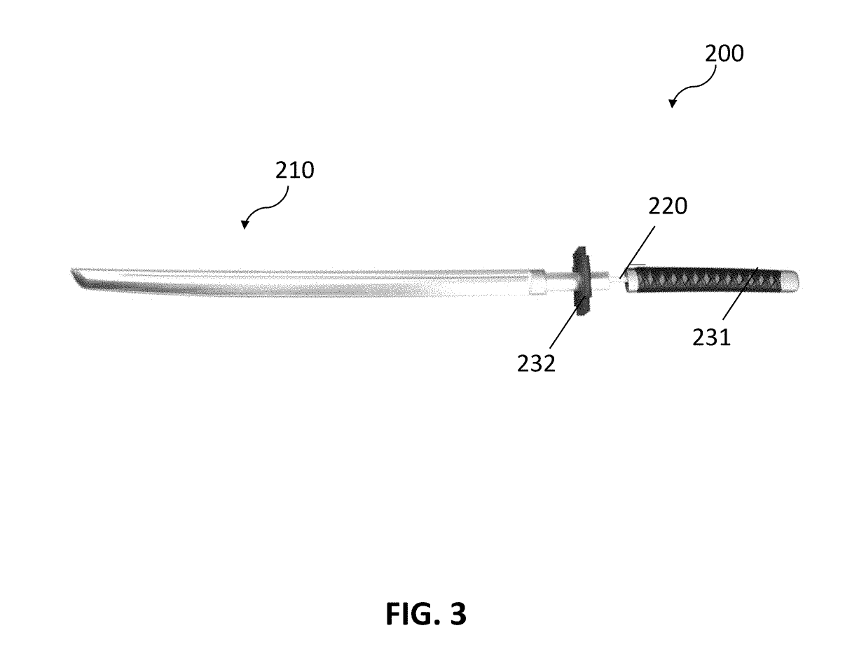

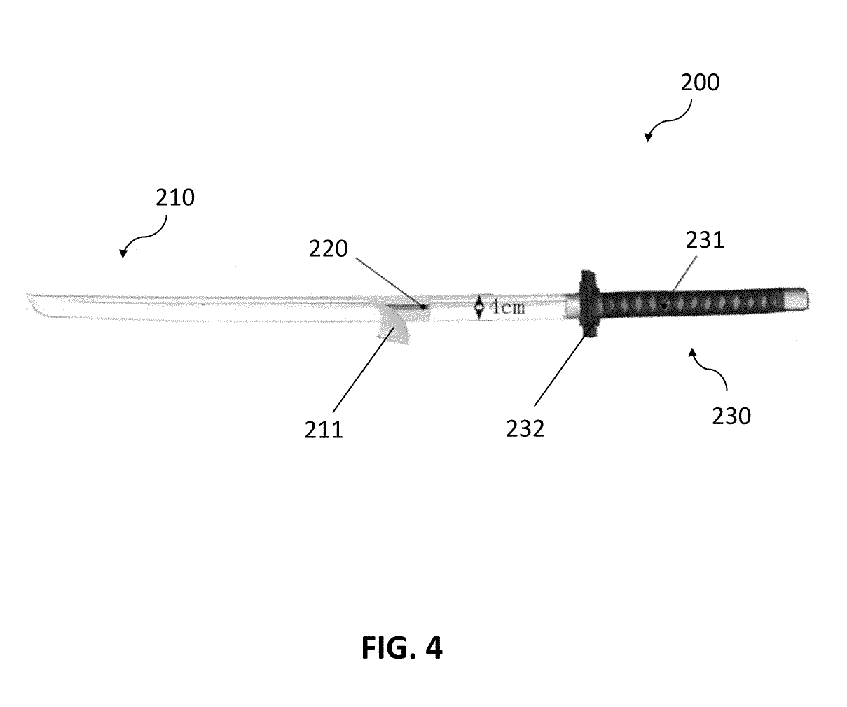

In another aspect, as shown in FIGS. 2 to 4, a non-metal weaponry instrument may include a main body 210, a backbone 220 and a handle portion 230, which includes a grip 231 and a hand guard 232. In an exemplary embodiment, the main body 210 is the final product of the coating method in the present invention. In another embodiment, the backbone 220 is made by fiberglass. In a further embodiment, one end of the backbone 220 is configured to insert to the cavity of the main body 210, while the other end thereof is inserted into a cavity of the grip 231 as shown in FIGS. 2a and 3. It is noted that as shown in FIG. 4, a protective film 211 in step S101 can be made by poly(vinyl chloride) (PVC), ethylene vinyl acetate (EVA), thermoplastic elastomer (TPE), or thermoplastic polyurethane (TPU). In one embodiment, the width of the main body 210 can be 4 cm.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method for coating a non-metallic object with a metallic layer comprising steps of:
step S101: manufacturing a polyurethane (PU) leather with a metallic surface, further comprising steps of: dissolving the PU resin in an organic solvent to form a compound; heating the compound at a predetermined heating temperature for attaching the compound to a base fabric to manufacture a PU leather, wherein the base fabric can be a tetoron/cotton (T/C) fabric or a mutispandex fabric; coating gold stamping oil on a surface of the PU leather, and attaching a gold stamping foil on the surface of the PU leather through a hot stamping machine; and disposing a transparent protective film on a surface of the gold stamping foil;
step S102: laminating, further comprising a step of attaching a composite material to the surface of the PU leather with the metallic surface in step S101;
step S103: molding, further comprising steps of: according to a shape of a final product, preparing an upper mold and a lower mold, and the upper mold and the lower mold respectively having an upper mold cavity and a lower mod cavity, and a gas vent to communicate with both the upper mold cavity and the lower mold cavity; securing the upper mold and the lower mold onto a cold press machine; heating the semi-manufactured product in step S102 in an oven until the conditions that composite material being shaped; taking out the semi-manufactured product and directly putting it into the lower molding cavity with a non-metal composite material as a backbone of the final product; closing the cold press machine to tightly combine the upper mold with the lower mold and processing the semi-manufactured product inside the cavities with a predetermined pressure and blowing air to form the semi-manufactured product into the designated shape; cooling down the semi-manufactured product in the cavities to a predetermined temperature by simultaneously cooling down the upper mold and the lower mold; and opening the cold press machine, taking out and trimming the product therein to complete the manufacturing process thereof.

2. The method for coating a non-metallic object of claim 1, wherein the organic solvent in step S101 is dimethylformamide (DMF).

3. The method for coating a non-metallic object of claim 1, wherein the heating temperature in step S101 is between 130 and 140° C.

4. The method for coating a non-metallic object of claim 1, wherein the operating temperature and pressure of the hot stamping machine in step S101 are respectively between 110 and 130° C. and between 10 to 60 KG.

5. The method for coating a non-metallic object of claim 1, wherein the protective film in step S101 is poly(vinyl chloride) (PVC), ethylene vinyl acetate (EVA), thermoplastic elastomer (TPE), or thermoplastic polyurethane (TPU).

6. The method for coating a non-metallic object of claim 1, wherein the thickness of the protective film in step S101 is in a range from 0.12 to 0.16 mm.

7. The method for coating a non-metallic object of claim 1, wherein the composite material in step S102 is ethylene vinyl acetate (EVA), cross-linked polyethylene foam (XPE), or chemically cross-linked polyethylene foam (XLPE).

8. The method for coating a non-metallic object of claim 1, wherein the upper mold and the lower mold in step S103 are made by aluminum or steel.

9. The method for coating a non-metallic object of claim 1, wherein the non-metal composite material as a backbone of the final product is fiberglass.
